(19) United States
(12) Patent Application Publication
(10) Pub. No.: US 2014/0332163 A1
(43) Pub. Date: Nov. 13, 2014

(54) LAMINATING APPARATUS OF MANUFACTURING ORGANIC LIGHT EMITTING DISPLAY

(71) Applicant: Samsung Display Co., Ltd., Yongin-City (KR)

(72) Inventors: InHyun HWANG, Hwaseong-si (KR); Jungwoo HWANG, Daegu (KR)

(73) Assignee: Samsung Display Co., Ltd., Yongin-City (KR)

(21) Appl. No.: 14/199,881

(22) Filed: Mar. 6, 2014

(30) Foreign Application Priority Data
May 9, 2013 (KR) 10-2013-0052619

(51) Int. Cl. B32B 37/00; B32B 37/10

(52) U.S. Cl. CPC B32B 37/0046; B32B 37/10
USPC 156/382

(57) ABSTRACT

A laminating apparatus for an organic light emitting display includes a vacuum chamber, a stage disposed in the vacuum chamber, the stage being configured to mounted receive an organic light emitting display substrate module, a sealing unit disposed in the vacuum chamber, the sealing unit being configured to heat and pressurize a peripheral area of the organic light emitting display substrate module and to form a pressurizing line, and a moving unit that controls a location of the sealing unit. The sealing unit has a plurality of heating/pressurizing lines, at least two of imaginary extension lines of the plurality of heating/pressurizing lines meet at a corner.

### CROSS-REFERENCE TO RELATED APPLICATION

This U.S. non-provisional patent application claims priority under 35 U.S.C. §119 of Korean Patent Application No. 10-2013-0052619, filed on May 9, 2013, the contents of which are hereby incorporated by reference in its entirety.

### BACKGROUND

1. Field of Disclosure

The present disclosure relates to a laminating apparatus of manufacturing an organic light emitting display. More particularly, the present disclosure relates to a laminating apparatus of manufacturing the organic light emitting display to seal an organic light emitting display substrate.

2. Description of the Related Art

An organic light emitting display has been spotlighted as a next generation display device since it is a self-emissive display device and has many favorable properties, e.g., fast response speed, low power consumption, wide viewing angle, etc. The organic light emitting display includes plural organic layers (or organic material patterns) disposed on a substrate.

Some organic layers are formed by a hybrid patterning system. To transfer an organic layer to the substrate, a donor film having a transfer layer containing the organic layer is disposed on the substrate to allow a transfer layer containing the organic material to contact with the substrate, and light is irradiated onto a portion of the donor film, thereby transferring the organic layer on the substrate.

During the transfer process, contaminants can be introduced between the substrate and the donor film. The contaminants may disturb the transfer process and causes defects in the organic layer transferred onto the substrate.

### SUMMARY

The present disclosure provides a laminating apparatus for an organic light emitting display device, which is capable of preventing defects from occurring in an organic layer due to contaminants.

Embodiments of the inventive concept provide a laminating apparatus of manufacturing an organic light emitting display including a vacuum chamber, a stage disposed in the vacuum chamber, the stage being configured to receive an organic light emitting display substrate module, a sealing unit disposed in the vacuum chamber, the sealing unit being configured to heat and pressurize a peripheral area of the organic light emitting display substrate module and to form a pressurizing line, and a moving unit that controls a location of the sealing unit. The sealing unit may have a plurality of heating/pressurizing lines and the plurality of heating pressurizing lines meet at least two corners.

The corner may have a radius of curvature.

The sealing unit may include a body portion and a heating portion built in the body portion.

The sealing unit may include a first and a second heating/pressuring lines extending in a first direction, the first and the second heating/pressurizing lines being spaced apart from each other and being parallel to each other, and a third heating/pressurizing line extending in the second direction perpendicular to the first direction, the third heating/pressurizing line connecting one end of the first heating/pressuring lines and one end the second heating/pressuring lines.

The first and the third heating/pressurizing lines may meet at one corner and the second and the third heating/pressurizing lines may meet at another corner.

The sealing unit may further includes a fourth heating/pressurizing line extending in the second direction, the fourth heating/pressurizing line connecting the other end portion of the first heating/pressurizing line and the other end portion of the second heating/pressurizing line. The first, second, third, and the fourth heating/pressurizing lines may meet at four corners.

Each of the four corners is a corner of the rectangle.

The each of the four corners has a radius of curvature.

The moving unit may include a vertical moving member that controls a vertical displacement of the sealing unit, a horizontal moving member that controls a horizontal displacement of the sealing unit, and a rotation member that rotates the sealing unit.

Embodiments of the inventive concept provide a laminating apparatus of manufacturing an organic light emitting display including a vacuum chamber, a stage disposed in the vacuum chamber and mounted with an organic light emitting display substrate module, a sealing unit disposed in the vacuum chamber to heat and pressurize a peripheral area of the organic light emitting display substrate module and to form a seal line at the peripheral area of the organic light emitting display substrate module, and a moving unit that controls a displacement of the sealing unit. The organic light emitting display substrate module may includes a first cover member disposed on a surface of the stage, an organic light emitting display substrate disposed on the first cover member, and a second cover member disposed on the first cover member to cover the substrate and including an organic material transferred onto a surface of the organic light emitting display substrate.

The second cover member may include a base film, a transfer layer disposed on the base film and including the organic material, and a light-heat conversion layer disposed between the base film and the transfer layer.

The organic light emitting display substrate module may further include an adhesive member disposed in the peripheral area to adhere the first cover member and the second cover member.

The sealing unit may include a body portion and a heating portion built in the body portion.

The sealing unit may include a plurality of heating/pressurizing lines connected to each other, and the heating/pressurizing lines form a closed-loop corresponding to the peripheral area of the organic light emitting display substrate module.

The heating/pressurizing lines may include first and second heating/pressurizing lines extended in a first direction and spaced apart from each other in a second direction substantially perpendicular to the first direction, a third heating/pressurizing line extended in the second direction to connect one portion of the first heating/pressurizing line and one portion of the second heating/pressurizing line, and a fourth heating/pressurizing line extended in the second direction to connect the other portion of the first heating/pressurizing line and the other portion of the second heating/pressurizing line.

The organic light emitting display substrate may include a first side extended in a first direction, a second side extended in a second direction substantially perpendicular to the first direction and connected to one portion of the first side, and a third side extended in the second direction and connected to the other portion of the first side. The sealing unit may include a first heating/pressuring line having a length longer than the first side, a second heating/pressurizing line connected to one portion of the first heating/pressurizing line and extended in the second direction and having a length equal to or greater than a half of a length of the second side, and a third heating/pressurizing line connected to the other portion of the first heating/pressurizing line and extended in the second direction and having a length equal to or greater than a half of a length of the third side.

The second heating/pressurizing line may be shorter than the second side and the third heating/pressurizing line is shorter than the third side. The moving unit may include a vertical moving member that controls a vertical displacement of the sealing unit, a horizontal moving member that controls a horizontal displacement of the sealing unit, and a rotation member that rotates the sealing unit.

The organic light emitting display substrate module may be primary heated and pressurized by the sealing unit that moves to a first position by the moving unit, the sealing unit may be rotated by the moving unit at a second position, and the organic light emitting display substrate module may be secondary heated and pressurized by the sealing unit that moves to a third position so as to form at least at least one overlap area which may be repeatedly heated and pressurized at a side of the peripheral area of the organic light emitting display substrate module in the second direction.

According to the above, the substrate is uniformly sealed to prevent contaminants from entering into the substrate module. In addition, the second cover member may be prevented from being torn or perforated when the first and the second cover members are removed from the substrate.

### BRIEF DESCRIPTION OF THE DRAWINGS

The above and other advantages of the present disclosure will become readily apparent with reference to the following detailed description and accompanying drawings wherein:

FIG. 1 is a front view showing a laminating apparatus for an organic light emitting display device according to an exemplary embodiment of the present disclosure;

FIG. 2 is a plan view showing a sealing unit according to an exemplary embodiment of the present disclosure;

FIG. 3 is a plan view showing an organic light emitting display substrate module sealed by the laminating apparatus according to an exemplary embodiment of the present disclosure;

FIG. 4A is a cross-sectional view showing the organic light emitting display substrate module sealed by the laminating apparatus according to an exemplary embodiment of the present disclosure;

FIG. 4B is a cross-sectional view showing the organic light emitting display substrate module under atmospheric pressure according to an exemplary embodiment of the present disclosure;

FIG. 5 is a cross-sectional view showing the organic light emitting display substrate module after a laminating process according to an exemplary embodiment of the present disclosure;

FIG. 6 is a front view showing a laminating apparatus for an organic light emitting display device according to another exemplary embodiment of the present disclosure;

FIG. 7 is a plan view showing a sealing unit according to another exemplary embodiment of the present disclosure;

FIG. 8 is a plan view showing an organic light emitting display substrate module sealed by the laminating apparatus according to another exemplary embodiment of the present disclosure; and

FIGS. 9A to 9D are views showing processes performed on the organic light emitting display substrate module carried out from the laminating apparatus.

### DETAILED DESCRIPTION

It will be understood that when an element or layer is referred to as being “on”, “connected to” or “coupled to” another element or layer, it can either be formed directly on, connected or coupled to the other element or layer, or formed with intervening elements or layers. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, the described elements, components, regions, layers and/or sections are not limited to the terms used. The terms are only used to distinguish one element, component, region, layer or section from another region, layer or section. Thus, a first element, component, region, layer or section discussed below could be termed a second element, component, region, layer or section without departing from the teachings of the present disclosure.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features may then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to limit of the inventive concept. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Hereinafter, embodiments of the present invention will be explained in detail with reference to the accompanying drawings.

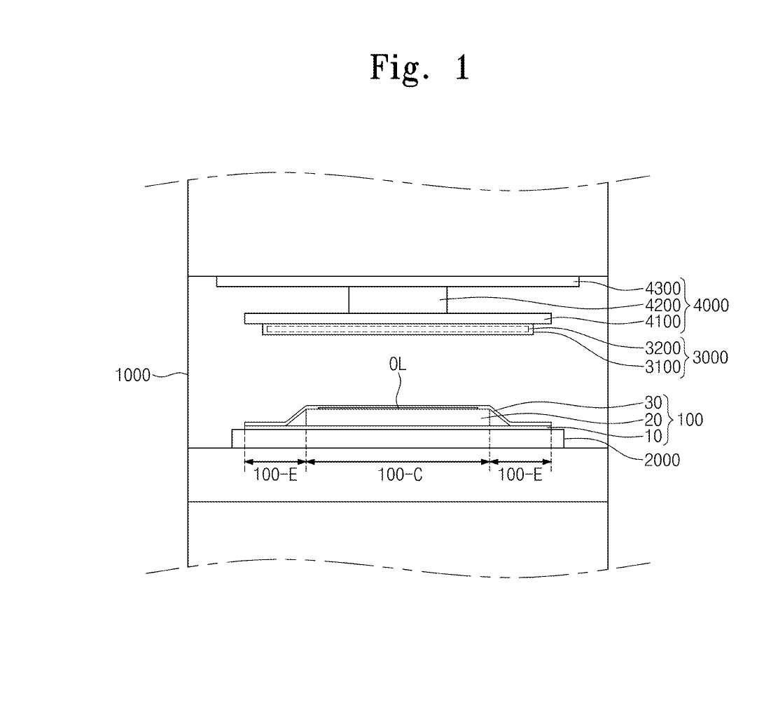

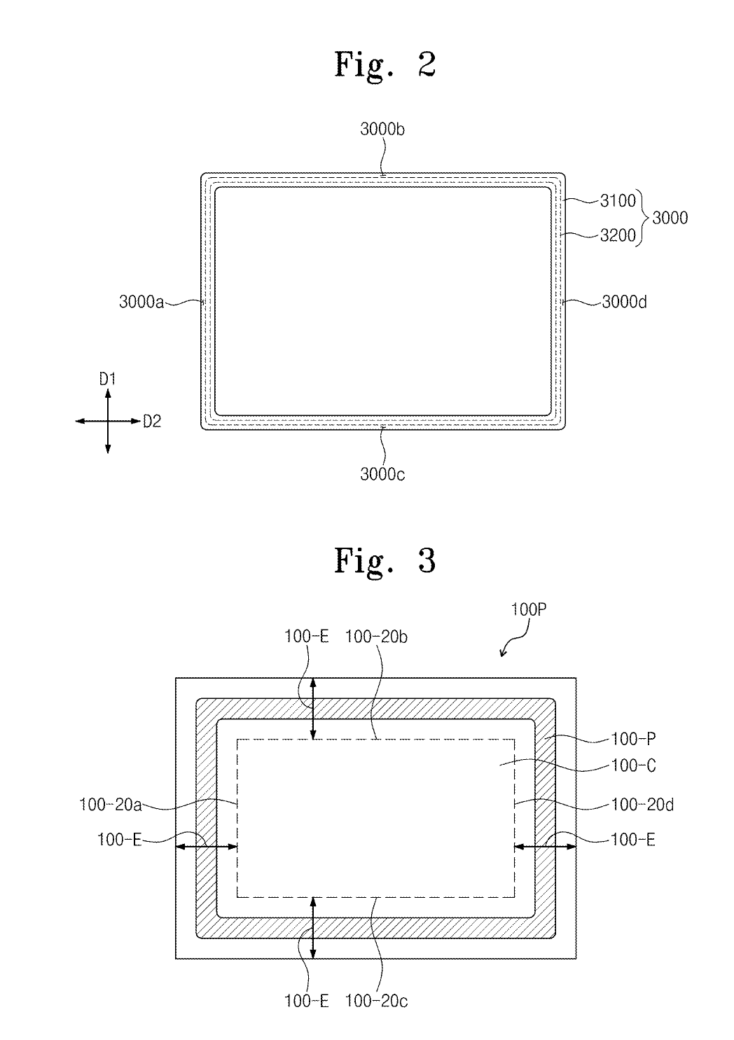

FIG. 1 is a front view showing a laminating apparatus for an organic light emitting display device according to an exemplary embodiment of the present disclosure having an OLED substrate unit loaded on a stage of the apparatus, FIG. 2 is a plan view showing a sealing unit according to an exemplary embodiment of the present disclosure, and FIG. 3 is a plan view showing an organic light emitting display substrate module sealed by the laminating apparatus according to an exemplary embodiment of the present disclosure.

Referring to FIG. 1, the lamination apparatus includes a vacuum chamber 1000, a stage 2000, a sealing unit 3000, and a moving unit 4000.

The vacuum chamber 1000 accommodates the stage 2000, the sealing unit 3000, and the moving unit 4000. The vacuum chamber 1000 maintains an inner space thereof in a vacuum state during a lamination process. The vacuum chamber 1000 further includes an entrance through which the organic light emitting display substrate module 100 (hereinafter, referred to as substrate module) can be loaded.

The stage 2000 is disposed at a lower portion of the inner space of the vacuum chamber 1000. The substrate module 100 is loaded on the stage 2000 and fixed to the stage 2000 during a sealing processing. The stage 2000 may have a shape similar to that of the substrate module 100. The stage 2000 may have a rectangular shape.

Although not shown in figures, the stage 2000 may further include a mounting member in which the substrate module 100 is mounted. The mounting member is protruded from an upper surface of the stage 2000 to accommodate the substrate module 100.

The mounting member may have at least two line shaped protrusion to support the substrate module 100. The mounting member may have a closed-loop shape to support all corners of the substrate module 100.

The mounting member aligns the substrate module 100 to the sealing unit 3000. The mounting member prevents the substrate module 100 from moving while the substrate module 100 is heated and pressurized.

As shown in FIG. 1, the substrate module 100 is placed on the upper surface of the stage 2000 during a sealing processing. The laminating apparatus according to the present exemplary embodiment heats and pressurizes the substrate module 100 to form the sealed substrate module 100P shown in FIG. 3. In the present exemplary embodiment, the sealed substrate module 100P has the same configurations as that of the substrate module 100, and thus elements included in the sealed substrate module 100P will be assigned with the same reference numerals as the substrate module 100.

Referring to FIGS. 1 and 3, each of the substrate module 100 and the sealed substrate module 100P includes a first cover member 10, a substrate 20, and a second cover member 30. The substrate module 100 is heated or pressured by the laminating apparatus according to the present exemplary embodiment. The laminating apparatus according to the present exemplary embodiment heats and pressurizes the substrate module 100 to form the sealed substrate module 100P shown in FIG. 3.

As show in FIG. 1, the first cover member 10 is disposed on the upper surface of the stage 2000 and makes contact with a lower surface of the substrate 20. The first cover member 10 is formed of a material having a thermo-plasticity. For instance, the first cover member 10 is formed of at least one material selected from thermo-plastic polymer materials, such as polyethylene, polyacetal resin, vinyl chloride resin, polystylene, acrylic resin, etc.

The substrate 20 is disposed on the first cover member 10. The substrate 20 may be glass or plastic. The substrate 20 may be an organic light emitting display substrate. Although not shown in figures, the substrate 20 includes a plurality of signal lines and a plurality of transistors connected to the signal lines.

The second cover member 30 is disposed on the first cover member 10 to cover the substrate 20. The second cover member 30 directly makes contact with the sealing unit 3000 when the substrate 20 is sealed.

The second cover member 30 includes a transfer layer such as organic material. Thus, the second cover member 30 may be a donor film including a base film, a transfer layer, and a light-heat conversion layer (not shown). The transfer layer is disposed on the base film and the light-heat conversion layer is disposed between the transfer layer and the base film.

The base film is transparent such that the light can be transmitted through the base film to the light-heat conversion layer. The base film includes at least one polymer material selected from the groups consisting of polyester, polyacryl, polyepoxy, polyethylene, polystylene, and polyethylenterephthalate.

The transfer layer OL is formed by depositing the organic material on the base layer. The transfer layer OL may be formed on the base layer having a light-heat conversion layer on it. The transfer layer OL transferred to the OLED substrate serves as a part of an organic light emitting device. For instance, the transfer layer OL serves as a hole transporting layer or an organic light emitting layer after being transferred to the OLED substrate.

The light-heat conversion layer is disposed between the base film and the transfer layer OL. The light-heat conversion layer helps easy separation of the transfer layer OL from the base film of the second cover member 30.

The light-heat conversion layer absorbs the light incident thereto and converts the absorbed light energy to heat energy. The light-heat conversion layer absorbs infrared rays or visible rays of the incident light.

In the manufacturing process of the organic light emitting display device, the second cover member 30 is disposed on the stage 2000 as a part of the substrate module 100. The second cover member 30 may be separately provided on the first cover member 10 and the substrate 20.

Referring to FIG. 3, each of the substrate module 100 and the sealed substrate module 100P includes a center area 100-C and a peripheral area 100-E. The peripheral area 100-E may include an adhesive member 40 as shown in FIG. 5. The adhesive member 40 is disposed between the first cover member 10 and the second cover member 30. Therefore, the adhesive member 40 is provided along the peripheral area of the first cover member 10 or along the peripheral area of the second cover member 30 when the organic light emitting display device is manufactured.

The adhesive member 40 improves an adhesive force between the first cover member 10 and the second cover member 30. A heat curable sealant may be used as the adhesive member 40, but the adhesive member 40 should not be limited to the heat curable sealant.

The substrate 20 is disposed in the center area 100-C. Thus, the first cover member 10, the substrate 20, and the second cover member 30 are disposed in the center area 100-C to be overlapped with each other.

The center area 100-C corresponds to the location of the substrate 20. The center area 100-C has four sides 100-20a, 100-20b, 100-20c, and 100-20d. The four sides 100-20a, 100-20b, 100-20c, and 100-20d correspond to sides of the substrate 20, respectively. Thus, the sides of the substrate 20 will be described as the four sides 100-20a, 100-20b, 100-20c, and 100-20d.

As shown in FIGS. 1 and 3, the substrate 20 is not disposed in the peripheral area 100-E. The first cover member 10 and the second cover member 30 are disposed in the peripheral area 100-E and overlapped with each other. The first and the second cover members 10 and 30 have an area greater than the substrate 20.

The sealed substrate module 100P further includes a pressurizing area 100-P. The pressurizing area 100-P surrounds the substrate 20 and is formed in the peripheral area 100-E.

The first cover member 10 and the second cover member 30 are adhered to each other by heat and pressure applied to the pressurizing area 100-P during the sealing process. The pressurizing area 100-P is corresponding to a seal line. The first cover member 10 and the second cover member 30 are deformed by the heat and adhered to each other by the pressure.

The pressurizing area 100-P is defined by the sealing unit 3000. Hereinafter, a relation between the sealing unit 3000 and the pressurizing area 100-P will be described in detail.

Referring to FIG. 1 again, the sealing unit 3000 is disposed at an upper portion of the inner space of the vacuum chamber 1000 and disposed on the substrate module 100. The sealing unit 3000 heats and pressurizes the peripheral area 100-E to seal the substrate module 100.

As show in FIGS. 1 and 2, the sealing unit 3000 includes a body portion 3100 and a heating portion 3200. The sealing unit 3000 may have at least two heating lines whose imaginary extension lines meet at a corner. The imaginary extension lines are extended from the heating/pressurizing lines respectively. The imaginary extension lines may be parallel to the peripheral area 100-E over the substrate module 100. The corner may be a rounded corner having a radius of curvature. The sealing unit 3000 surrounds the substrate during the lamination process and may have a separation distance from edges of the substrate 20 to the inner edges of the sealing unit 3000. The heating/pressurizing lines may form a seal line. The body portion 3100 makes contact with the second cover member 30 to pressurize the peripheral area 100-E.

The heating portion 3200 is built in the body portion 3100 and applies heat to the peripheral area 100-E. The heating portion 3200 may be a heating wire disposed along the shape of the body portion 3100.

Referring to FIG. 2 again, the sealing unit 3000 includes a plurality of heating/pressurizing lines 3000a, 3000b, 3000c, and 3000d, which are connected to each other. The heating/pressurizing lines 3000a to 3000d connected to each other includes first, second, third, and fourth heating/pressurizing lines.

The first heating/pressurizing line 3000a and the fourth heating/pressurizing line 3000d are extends in a first direction D1 and arranged in a second direction D2 substantially perpendicular to the first direction D1 to be spaced apart from each other.

The second heating/pressurizing line 3000b and the third heating/pressuring line 3000c are extends in the second direction D2. The second heating/pressurizing line 3000b is connected to one end portion of the first heating/pressurizing line 3000a and one end portion of the fourth heating/pressurizing line 3000d, and the third heating/pressurizing line 3000c is connected to the one end portion of the first heating/pressurizing line 3000a and the one end portion of the fourth heating/pressurizing line 3000d.

As shown in FIG. 2, the first to fourth heating/pressurizing lines 3000a to 3000d form a closed-loop shape to heat and pressurize the peripheral area 100-E of the substrate module 100. The closed-loop shape may be, but not limited to, a rectangular shape.

The sealing unit 3000 includes the heating portion 3200 and the body portion 3100 surrounding the heating portion 3200. The heating portion 3200 is disposed along the shape of the body portion 3100. The sealing unit may form a closed-loop shape such as a rectangular shape. The rectangular shaped sealing unit may include a rounded corner having a radius of curvature. The sealing unit 3000 surrounds the substrate during the lamination process and may have a separation distance from edges of the substrate 20 to the inner edges of the sealing unit 3000.

The heating portion 3200 substantially simultaneously discharges the heat through the entire portion thereof or discharges the heat in sequence to heat the peripheral area 100-E.

As described above, the pressurizing area 100-P is formed while the sealing unit 3000 heats and pressurizes the peripheral area 100-E. Thus, the pressurizing area 100-P has the shape corresponding to that of the sealing unit 3000.

Referring to FIGS. 2 and 3 again, the heating portion 3200 has the same shape as the body portion 3100. Accordingly, the pressurizing area 100-P has the same shape as the closed-loop line of the sealing unit 3000.

However, the shape of the heating portion 3200 should not be limited to the described embodiments. That is, the heating portion 3200 includes plural point light sources arranged along the shape of the body portion 3100 and spaced apart from each other at a predetermined distance. In this case, the pressurizing area 100-P has the shape corresponding to the point light sources.

As shown in FIG. 1, the moving unit 4000 is disposed at the upper portion of the vacuum chamber 1000 to control a movement of the sealing unit 3000.

The moving unit 4000 helps the sealing unit 3000 in making contact with the peripheral area 100-E. The moving unit 4000 moves the sealing unit 3000 up and down to apply pressure to the peripheral area 100-E. The moving unit 4000 includes a fixing member 4100, a vertical moving member 4200, and a horizontal moving member 4300.

The fixing member 4100 is coupled to the sealing unit 300 and supports the sealing unit 300. The fixing member 4100 may have a rectangular plate shape to support the entire surface of the sealing unit 3000, but the shape of the fixing member 4100 is not limited to the rectangular plate shape.

The vertical moving member 4200 controls a vertical movement of the sealing unit 3000. The vertical moving member 4200 allows the sealing unit 3000 to move up and down to pressurize the substrate module 100. The vertical moving member 4200 may be, but not limited to, a shaft connected to the fixing member 4100.

The horizontal moving member 4300 controls a horizontal movement of the sealing unit 3000. The horizontal moving member 4300 allows the sealing unit 3000 to be disposed on the substrate module 100. The horizontal moving member 4300 aligns the sealing unit 3000 and the peripheral area 100-E.

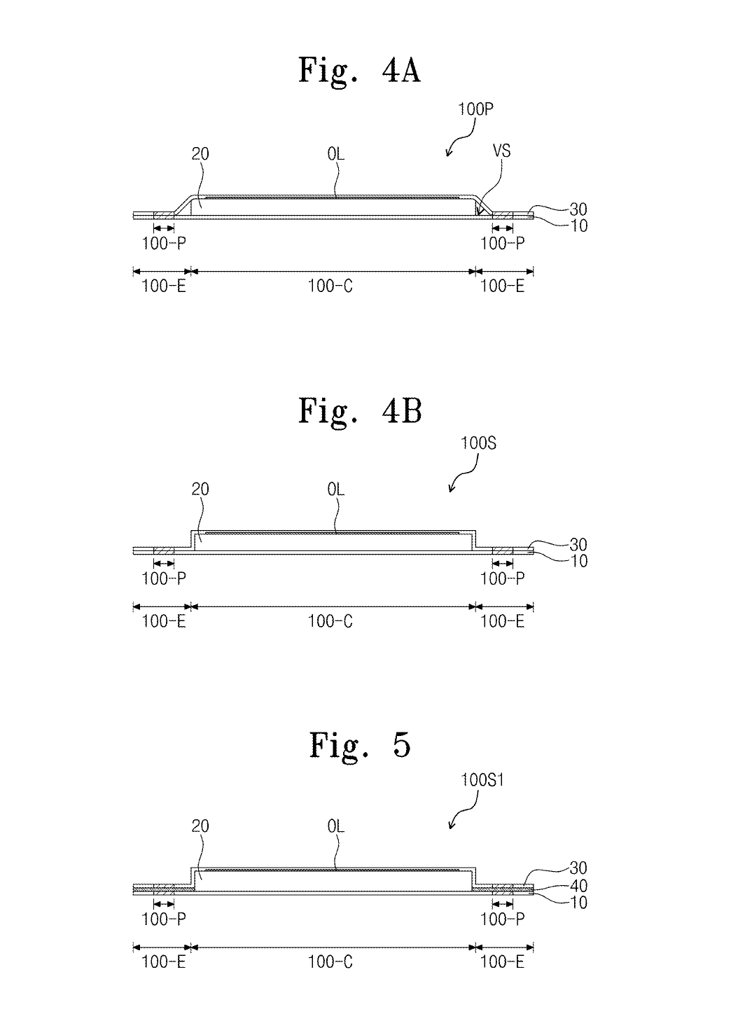

FIG. 4A is a cross-sectional view showing the sealed organic light emitting display substrate module in a vacuum and FIG. 4B is a cross-sectional view showing the organic light emitting display substrate module unloaded from the vacuum chamber 1000 according to an exemplary embodiment of the present disclosure. In FIGS. 4A and 4B, the same reference numerals denote the same elements in FIGS. 1 to 3, and thus detailed descriptions of the same elements will be omitted. The sealed organic light emitting display substrate module may further including an adhesive member 40 as shown in FIG. 5.

Referring to FIG. 4A, the sealed substrate module 100P includes a vacuum space VS. The vacuum space VS is placed between the substrate 20 and the pressurizing area 100-P and surrounded by the first cover member 10 and the second cover member 30. The vacuum space VS exists only when the sealed substrate module is in the vacuum chamber 1000.

Referring to FIG. 4B, the unloaded substrate module 100S indicates the substrate module 100P when the sealed substrate module is unloaded from the vacuum chamber 1000 and under atmospheric pressure. The unloaded substrate module 100S under atmospheric pressure is different from the sealed substrate module 100P when the sealed substrate module is in the vacuum chamber 1000. The second cover member 30 is adhered to the substrate 20 and the first cover member 10 without visible space between the first cover member 10, the substrate 20 and the second cove member 30 due to the atmospheric pressure. The substrate 20 is isolated from an external environment even if it is under atmospheric pressure because it is surrounded by the first cover member 10 and the second cover member 30. Accordingly, the substrate 20 may be prevented from contamination during backend processes.

FIG. 5 is a cross-sectional view showing the unloaded organic light emitting display substrate module after finishing the laminating process according to an exemplary embodiment of the present disclosure.

Referring to FIG. 5, the unloaded substrate module 100S1 after finishing the laminating process may further include an adhesive member 40 disposed in the peripheral area 100-E.

The adhesive member 40 is disposed between the first cover member 10 and the second cover member 30. Therefore, the adhesive member 40 is provided along the peripheral area of the first cover member 10 or along the peripheral area of the second cover member 30 when the organic light emitting display device is manufactured.

The adhesive member 40 improves an adhesive force between the first cover member 10 and the second cover member 30. A heat curable sealant may be used as the adhesive member 40, but the adhesive member 40 should not be limited to the heat curable sealant.

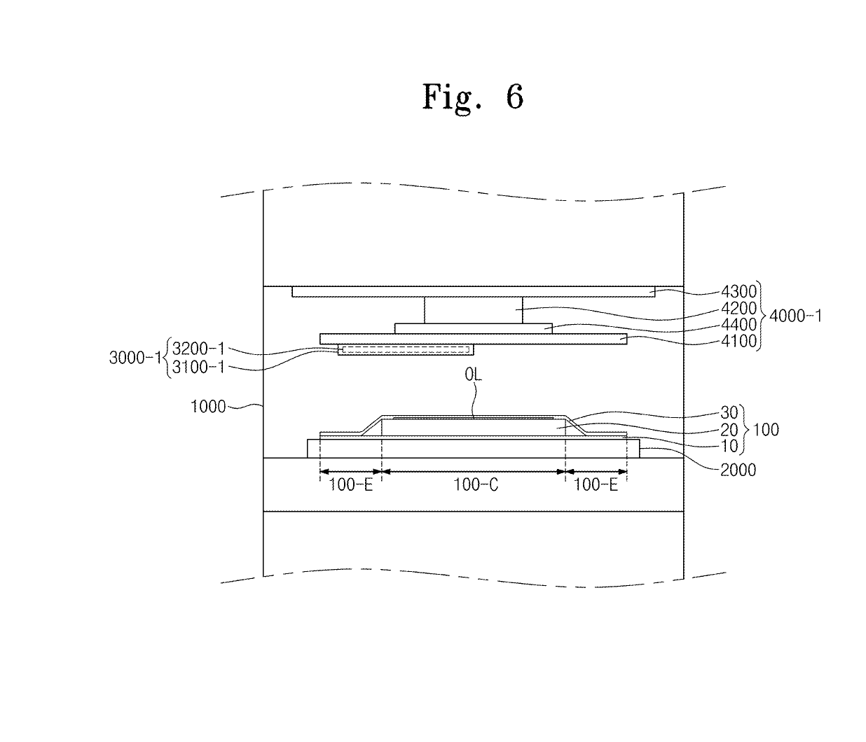

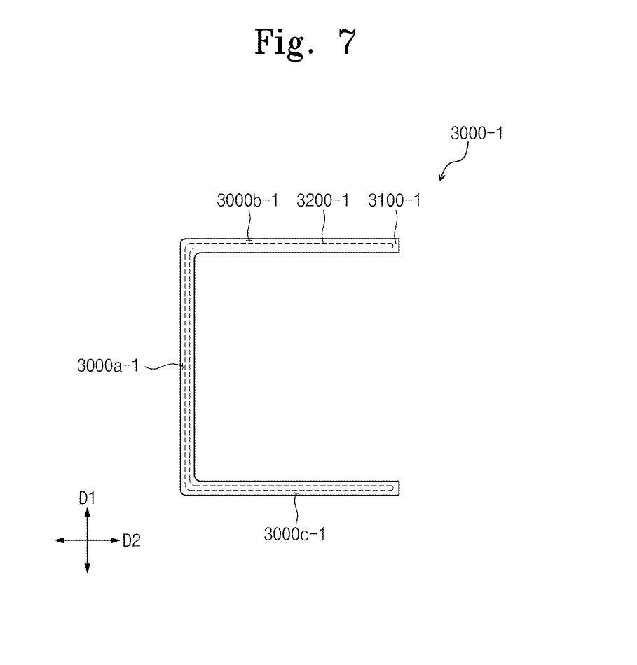

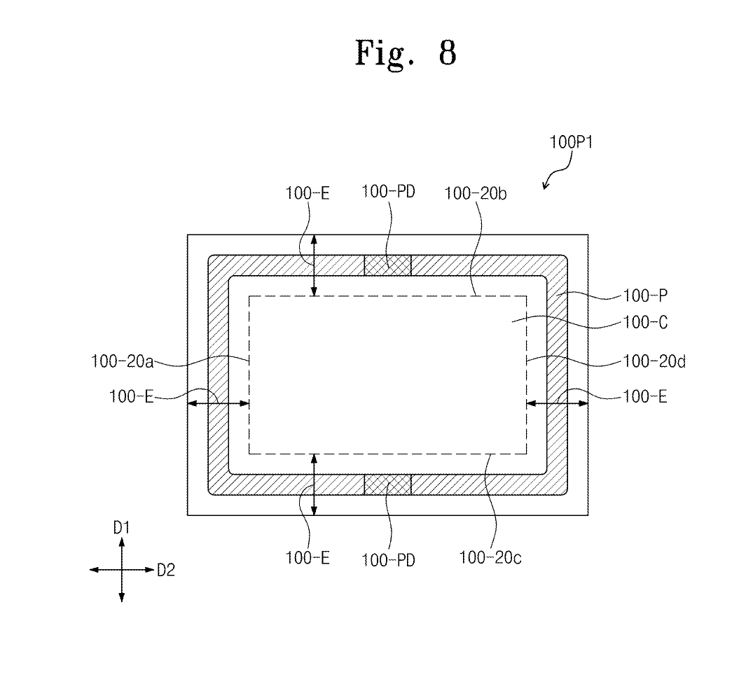

FIG. 6 is a front view showing a laminating apparatus for an organic light emitting display device according to another exemplary embodiment of the present disclosure, FIG. 7 is a plan view showing a sealing unit according to another exemplary embodiment of the present disclosure, and FIG. 8 is a plan view showing an organic light emitting display substrate module sealed by the laminating apparatus according to another exemplary embodiment of the present disclosure. In FIGS. 6 to 8, the same reference numerals denote the same elements in FIGS. 1 to 5, and thus detailed descriptions of the same elements will be omitted.

Referring to FIG. 6, a moving unit 4000-1 further includes a rotation member 4400. The rotation member 4400 rotates a sealing unit 3000-1.

The rotation member 4400 is disposed between the vertical moving member 4200 and the fixing member 4100 to connect the vertical moving member 4200 and the fixing member 4100. In addition, although not shown in figures, the rotation member 4400 may be disposed between the vertical moving member 4200 and the horizontal moving member 4300.

As shown in FIGS. 6 and 7, the sealing unit 3000-1 may have various shapes, and the heating/pressurizing lines may not form the closed-loop shape.

The shape of the sealing unit 3000-1 will be described in detail with reference to FIGS. 7 and 8. In FIG. 8, the substrate 20 is not shown, but the center area 100-C corresponds to the location of the substrate 20.

Accordingly, each side of the substrate 20 has the same length and location as the corresponding side of the center area 100-C. Hereinafter, the sides of the substrate 20 will be described as the sides of the center area 100-C.

The first side 100-20a and the fourth side 100-20d extend in the first direction D1 and are substantially parallel to each other.

The second side 100-20b is connected between one end portion of the first side 100-20a and one end portion of the fourth side 100-20d and extends in the second direction. The third side 100-20c extends in the second direction D2 and faces the second side 100-20b, and the third side 100-20c is connected to between the other end portion of the first side 100-20a and the other end portion of the fourth side 100-20d.

Referring to FIGS. 7 and 8, the sealing unit 3000-1 comprises a body portion 3100-1 and a heating portion 3200-1. The heating portion 3200-1 is built in the body portion 3100-1 and applies heat to the peripheral area 100-E. The heating portion 3200-1 may be a heating wire disposed along the shape of the body portion 3100-1.

The sealing unit 3000-1 includes a first heating/pressurizing line 3000a-1, a second heating/pressurizing line 3000b-1, and a third heating/pressurizing line 3000c-1. The first heating/pressurizing line 3000a-1 extends in the first direction D1. The first heating/pressurizing line 3000a-1 heats and pressurizes the area disposed substantially in parallel to the first side 100-20a of the peripheral area 100-E. Therefore, the first heating/pressurizing line 3000a has a length longer than the first side 100-20a.

The second heating/pressurizing line 3000b-1 extends in the second direction D2. The second heating/pressurizing line 3000b is connected to one end portion of the first heating/pressurizing line 3000a-1. The second heating/pressurizing line 3000b-1 has a length equal to or greater than half the length of the second side 100-20b.

The third heating/pressurizing line 3000c-1 extends in the second direction D2 from the other end portion of the first heating/pressurizing line 3000a-1. The third heating/pressurizing line 3000c-1 has a length equal to or greater than half the length of the second side 100-20b.

The second and the third heating/pressurizing lines 3000b-1 and 3000c-1 may have the same length, but they should not be limited thereto or thereby. That is, the second and the third heating/pressurizing lines 3000b-1 and 3000c-1 may have different lengths from each other.

The sealing unit 3000-1 may include rounded corners at points where two heating/pressurizing lines meet. The rounded corner may have a radius of curvature. The sealing unit 3000 may surround three edges of the substrate 20 during the lamination process and may have a separation distance from edges of the substrate 20 to the inner edges of the sealing unit 3000.

As show in FIG. 8, a sealed substrate module 100P1 further includes at least one overlap area 100-PD. The overlap area 100-PD is disposed on the pressurizing area 100-P.

As described above, the pressurizing area 100-P has the similar shape to that of the sealing unit 3000-1. Thus, the sealing unit 3000-1 according to the present exemplary embodiment heats and pressurizes the peripheral area 100-E at least two times to seal the peripheral area 100-E.

For a primary heating and pressurizing process, the moving unit 4000 places the sealing unit 3000-1 at a first position. The first position corresponds to the area in which the first heating/pressurizing line 3000a-1 is disposed to surround the first side 100-20a, a portion of second side 100-20b near the first side 100-20a and a portion of third side 100-20c near the first side 100-20a.

Through the primary heating and pressurizing process, the sealing unit 3000-1 seals the area near the first side 100-20a of the peripheral area 100-E, the portion of second side 100-20b near the first side 100-20a and the portion of third side 100-20c near the first side 100-20a.

After the primary heating and pressurizing process, the sealing unit 3000-1 moves to a second position by the vertical moving member 4200 and the horizontal moving member 4300. The second position is spaced apart from the substrate module 100 along the vertical direction.

The sealing unit 3000-1 is rotated to the second position by the rotation member 4400. In addition, the sealing unit 3000-1 is placed at a third position by the vertical moving member 4200 and the horizontal moving member 4300.

The third position corresponds to the area in which the first heating/pressurizing line 3000a-1 is disposed to surround the fourth side 100-20d, a portion of second side 100-20b near the fourth side 100-20d and a portion of third side 100-20c near the fourth side 100-20d. The third position may share a line of symmetry with the first position.

Through the secondary heating and pressurizing process, the sealing unit 3000-1 seals the area near the fourth side 100-20d of the peripheral area 100-E, the portion of second side 100-20b near the fourth side 100-20d and the portion of third side 100-20c near the fourth side 100-20d.

Portions of the pressurizing area 100-P corresponding to the overlapping area of the first position and the second position may be repeatedly heated and pressurized through the primary and the secondary heating and pressurizing processes.

As shown in FIG. 8, the overlap area 100-PD may be formed on the peripheral area 100-E through the primary and secondary heating and pressurizing processes.

Thus, the overlap area 100-PD may be defined by the overlap area between the area sealed by the second heating/pressurizing line 3000b-1 during the primary heating and pressurizing process and the area sealed by the third heating/pressurizing line 3000c-1 during the secondary heating and pressurizing process.

In addition, the overlap area 100-PD may be defined by the overlap area between the area sealed by the third heating/pressurizing line 3000c-1 during the primary heating and pressurizing process and the area sealed by the second heating/pressurizing line 3000b-1 during the secondary heating and pressurizing process.

Since the overlap area 100-PD is formed by heating and pressurizing the peripheral area 100-E using the sealing unit 3000-1 through at least two times, the first cover member 10 and the second cover member 30 are strongly attached to each other in the overlap area 100-PD when compared to that in the pressurizing area 100-P.

As shown in FIG. 8, at least one overlap area 100-PD is placed at the side of the peripheral area 100-E in the second direction D2. However, the overlap area 100-PD is placed at the side of the peripheral area 100-E in the first direction D1.

The overlap area 100-PD is disposed along the pressurizing area 100-P and placed at various positions rather than the sides of the peripheral area 100-E, but it is required to be placed at the sides of the pressurizing area 100-P to easily remove the first cover member 10 and the second cover member 30.

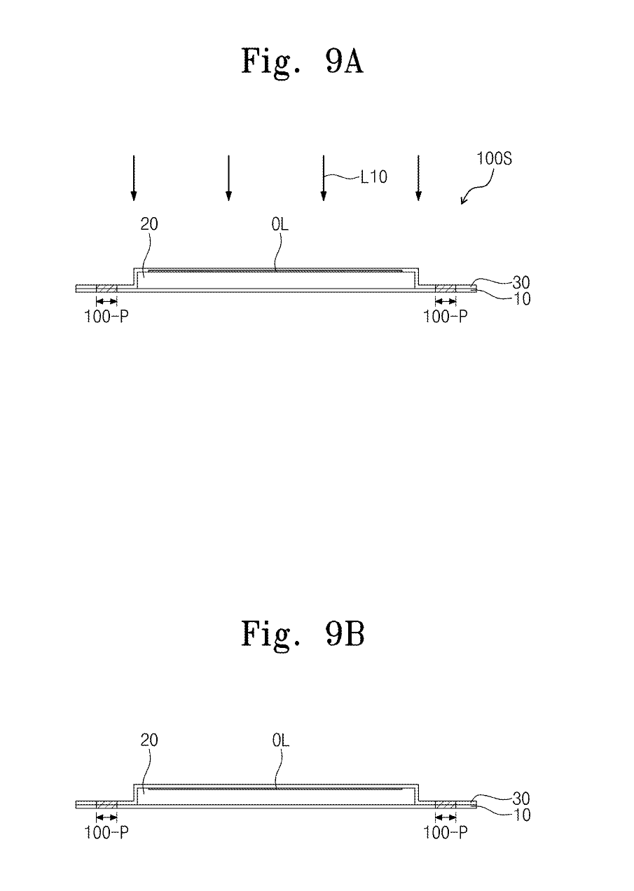

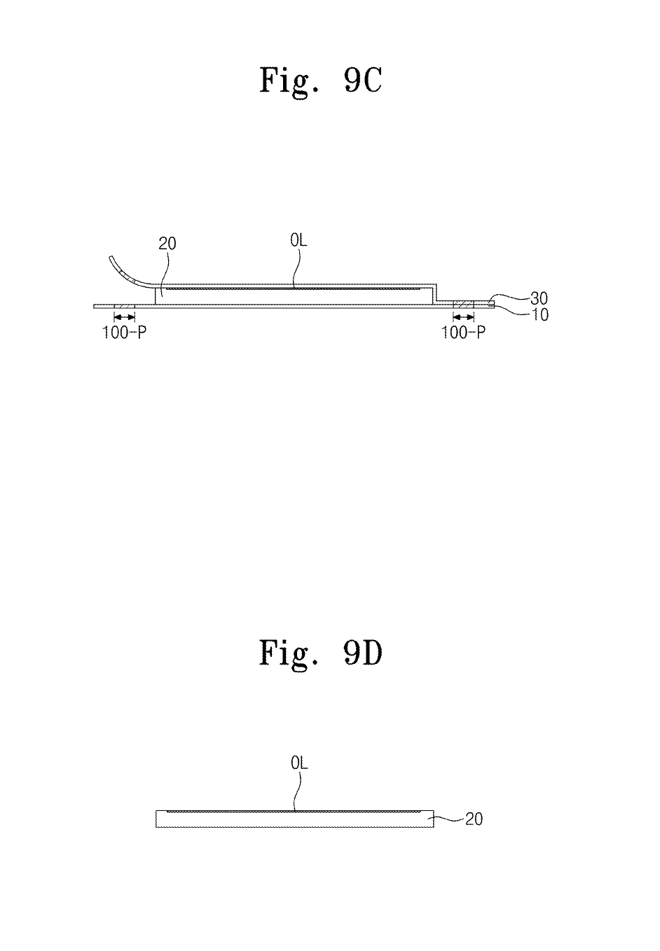

FIGS. 9A to 9D are views showing processes to be performed on the organic light emitting display substrate module after the laminating apparatus. In FIGS. 9A to 9D, the same reference numerals denote the same elements in FIGS. 1 to 8, and thus detailed descriptions of the same elements will be omitted.

Referring to FIG. 9A, a light irradiation process is performed on the substrate module 100S unloaded from the vacuum chamber 1000. During the light irradiation process, a laser beam L10 is irradiated onto the second cover member 30 of the unloaded substrate module 100S.

Referring to FIG. 9B, when the laser beam L10 is irradiated, the transfer layer OL is transferred onto the substrate 20. As described above, since the substrate 20 of the unloaded substrate module 1005 is sealed, the transfer layer OL may be transferred onto the substrate 20 without being contaminated.

Referring to FIGS. 9C and 9D, when the organic layer is formed on the substrate 20 by transferring the transfer layer OL, the transferred substrate module is disassembled. In this case, the first cover member 10 and the second cover member 30 are removed from the substrate 20.

According to the shape of the sealing unit 3000, the pressurizing area 100-P may not include the overlap area 100-PD. Although the overlap area 100-PD exists, the overlap area 100-PD is placed at the sides of the pressurizing area 100-P. Thus, the first and second cover members 10 and 30 may be prevented from being torn or perforated when the first and the second cover members 10 and 30 are removed from the substrate 20.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A laminating apparatus of manufacturing an organic light emitting display, comprising:
a vacuum chamber;
a stage disposed in the vacuum chamber, the stage being configured to receive an organic light emitting display substrate module;
a sealing unit disposed in the vacuum chamber, the sealing unit being configured to heat and pressurize a peripheral area of the organic light emitting display substrate module and to form a seal line; and
a moving unit that controls a location of the sealing unit,
wherein the sealing unit comprises a plurality of heating/pressurizing lines and the plurality of heating pressurizing lines meet at least two corners.

2. The laminating apparatus of claim 1, wherein the corners have a radius of curvature.

3. The laminating apparatus of claim 1, wherein the sealing unit comprises a body portion and a heating portion built in the body portion.

4. The laminating apparatus of claim 1, wherein the sealing unit comprises
a first and a second heating/pressuring lines extending in a first direction, the first and the second heating/pressurizing lines being spaced apart from each other and being parallel to each other, and a third heating/pressurizing line extending in the second direction perpendicular to the first direction, the third heating/pressurizing line connecting one end of the first heating/pressuring lines and one end the second heating/pressuring lines.

5. The laminating apparatus of claim 4, wherein the first and the third heating/pressurizing lines meet at one corner and the second and the third heating/pressurizing lines meet at another corner.

6. The laminating apparatus of claim 5, wherein the corners have a radius of curvature.

7. The laminating apparatus of claim 4, wherein the sealing unit further comprises:
a fourth heating/pressurizing line extending in the second direction, the fourth heating/pressurizing line connecting the other end portion of the first heating/pressurizing line and the other end portion of the second heating/pressurizing line, and
wherein the first, second, third, and the fourth heating/pressurizing lines meet at four corners.

8. The laminating apparatus of claim 7, wherein each of the four corners is a corner of the rectangle.

9. The laminating apparatus of claim 8, wherein the each of the four corners has a radius of curvature.

10. The laminating apparatus of claim 1, wherein the moving unit comprises:
a vertical moving member that controls a vertical displacement of the sealing unit;
a horizontal moving member that controls a horizontal displacement of the sealing unit; and
a rotation member that rotates the sealing unit.

11. A laminating apparatus of manufacturing an organic light emitting display, comprising:
a vacuum chamber;
a stage disposed in the vacuum chamber and mounted with an organic light emitting display substrate module;
a sealing unit disposed in the vacuum chamber to heat and pressurize a peripheral area of the organic light emitting display substrate module and to form a seal line at the peripheral area of the organic light emitting display substrate module; and
a moving unit that controls a displacement of the sealing unit.

12. The laminating apparatus of claim 11, wherein the organic light emitting display substrate module comprising:
a first cover member disposed on a surface of the stage;
an organic light emitting display substrate disposed on the first cover member; and
a second cover member disposed on the first cover member to cover the substrate and including an organic material transferred onto a surface of the organic light emitting display substrate, and wherein the second cover member comprises:
a base film;
a transfer layer disposed on the base film and including the organic material; and
a light-heat conversion layer disposed between the base film and the transfer layer.

13. The laminating apparatus of claim 12, wherein the organic light emitting display substrate module further comprises an adhesive member disposed in the peripheral area to adhere the first cover member and the second cover member.

14. The laminating apparatus of claim 11, wherein the sealing unit comprises a body portion and a heating portion built in the body portion.

15. The laminating apparatus of claim 11, wherein the sealing unit comprises a plurality of heating/pressurizing lines connected to each other, and the heating/pressurizing lines form a closed-loop corresponding to the peripheral area of the organic light emitting display substrate module.

16. The laminating apparatus of claim 15, wherein the heating/pressurizing lines comprise:
first and second heating/pressurizing lines extended in a first direction and spaced apart from each other in a second direction substantially perpendicular to the first direction;
a third heating/pressurizing line extended in the second direction to connect one portion of the first heating/pressurizing line and one portion of the second heating/pressurizing line; and
a fourth heating/pressurizing line extended in the second direction to connect the other portion of the first heating/pressurizing line and the other portion of the second heating/pressurizing line.

17. The laminating apparatus of claim 11, wherein the organic light emitting display substrate comprises a first side extended in a first direction, a second side extended in a second direction substantially perpendicular to the first direction and connected to one portion of the first side, and a third side extended in the second direction and connected to the other portion of the first side, and the sealing unit comprises:
a first heating/pressuring line having a length longer than the first side;
a second heating/pressurizing line connected to one portion of the first heating/pressurizing line and extended in the second direction and having a length equal to or greater than a half of a length of the second side; and
a third heating/pressurizing line connected to the other portion of the first heating/pressurizing line and extended in the second direction and having a length equal to or greater than a half of a length of the third side.

18. The laminating apparatus of claim 17, wherein the second heating/pressurizing line is shorter than the second side and the third heating/pressurizing line is shorter than the third side.

19. The laminating apparatus of claim 17, wherein the moving unit comprises:
a vertical moving member that controls a vertical displacement of the sealing unit;
a horizontal moving member that controls a horizontal displacement of the sealing unit; and
a rotation member that rotates the sealing unit.

20. The laminating apparatus of claim 17, wherein the organic light emitting display substrate module is primary heated and pressurized by the sealing unit that moves to a first position by the moving unit, the sealing unit is rotated by the moving unit at a second position, and the organic light emitting display substrate module is secondary heated and pressurized by the sealing unit that moves to a third position so as to form at least at least one overlap area which is repeatedly heated and pressurized at a side of the peripheral area of the organic light emitting display substrate module in the second direction.
